(19) United States
(12) Patent Application Publication
(10) Pub. No.: US 2015/0347939 A1
(43) Pub. Date: Dec. 3, 2015

(54) FORMING RECOMMENDATIONS USING CORRELATIONS BETWEEN WELLNESS AND PRODUCTIVITY

(71) Applicant: Oracle International Corporation, Redwood Shores, CA (US)

(72) Inventors: Nigel KING, San Mateo, CA (US); Elizabeth LINGG, Pleasanton, CA (US); Kent Arthur SPAULDING, Portland, OR (US); Reza B'FAR, Huntington Beach, CA (US)

(73) Assignee: ORACLE INTERNATIONAL CORPORATION, Redwood Shores, CA (US)

(21) Appl. No.: 14/293,954

(22) Filed: Jun. 2, 2014

(51) Int. Cl. G06Q 10/06; G06F 19/00

(52) U.S. Cl. CPC G06Q 10/0639; G06F 19/345

(57) ABSTRACT

A method, system, and computer program product for computer-aided administration of wellness programs. Processing commences upon collecting first observations based on direct or indirect productivity measurements, then collecting second observations pertaining based on direct or indirect employee wellness measurements. Correlations between the first observations and the second observations are made, and based on the correlations, recommendations are formed. Recommendations can be emitted to an employee or to a program manager. The employee productivity measurements comprise working hours per time period, absentee hours per time period, units produced over a time period, revenue per employee, profit per employee, revenue per work hour, and/or profit per work hour. The employee wellness measurements comprise an assessment of a number of hours of exercise per time period, a number of steps taken per time period, a nutrition intake per time period, a body characteristic, and/or a quantity of caffeine-fortified beverages consumed per time period.

### RELATED APPLICATIONS

The present application is related to co-pending U.S. patent application Ser. No. 14/293,890, entitled, “USING CROWDSOURCING CONSENSUS TO DETERMINE NUTRITIONAL CONTENT OF FOODS DEPICTED IN AN IMAGE” (Attorney Docket No. ORA140467-US-NP), filed on even date herewith; and the present application is related to co-pending U.S. patent application Ser. No. 14/293,919, entitled “OPTIMIZING WELLNESS PROGRAM SPENDING” (Attorney Docket No. ORA140562-US-NP), filed on even date herewith; each of which are hereby incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of computer-aided administration of wellness programs and more particularly to techniques for forming recommendations using correlations between wellness and productivity.

### BACKGROUND

Organizations often sponsor workplace programs to improve the overall working environment. In some cases, such sponsored programs are substantially driven by business objectives (e.g., to attract, train and retain the best talent in the world). In some cases the benefits of corporate sponsorship of such programs (e.g., wellness programs) appears to accrue primarily to individuals (e.g., employees) rather than to shareholders. Yet, if it could be established that benefits of the corporate-sponsored programs (e.g., wellness programs) accrue both to the shareholders as well as to individuals, then shareholders would more strongly support ongoing corporate sponsorship. Further, if it can be shown that certain actions taken (such as changes made to an employee program and/or a wellness program) result in, or can be predicted to result in, improved financial or other performance improvements, then the programs might be augmented and/or fine-tuned.

Unfortunately, while there are individual health-centric measurement tools, and while there are corporate financial performance and other corporate performance measurement tools, there are no systems that correlate aspects of a wellness program to aspects of corporate performance. What is needed is a technique or techniques for capturing measurements and calculating correlations between wellness and productivity. What are needed are tools to support:
Measurements and correlations between individual employee participation and individual employee productivity;
Measurements and correlations between aggregate employee participation in a wellness program and corporate financial performance;
Measurements and correlations between enterprise-wide administration of a wellness program to corporate financial performance.

None of the aforementioned legacy approaches achieve the capabilities of the herein-disclosed techniques for forming recommendations using correlations between wellness and productivity. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for forming recommendations using correlations between wellness and productivity.

Some embodiments commence upon collecting first observations pertaining to employee productivity, the first observations based on direct or indirect productivity measurements, then collecting second observations pertaining to employee wellness based on direct or indirect employee wellness measurements. Correlations between the first observations and the second observations are made, and based on the correlations, recommendations are formed. Recommendations can be emitted to an employee or to a program manager. The employee productivity measurements comprise working hours per time period, absentee hours per time period, units produced over a time period, revenue per employee, profit per employee, revenue per work hour, and/or profit per work hour. The employee wellness measurements comprise an assessment of a number of hours of exercise per time period, a number of steps taken per time period, a nutrition intake per time period, a body characteristic, and/or a quantity of caffeine-fortified beverages consumed per time period.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A exemplifies a use model and data flow as used in systems for forming recommendations using correlations between wellness and productivity, according to some embodiments.

FIG. 1B exemplifies an interface between a wellness program system and a system for forming recommendations using correlations between wellness and productivity, according to an embodiment.

FIG. 1C is a block diagram of a scatter plot correlation system for forming recommendations using correlations between individual wellness measures and individual productivity measures, according to some embodiments.

FIG. 1D is a block diagram of a scatter plot correlation system for forming recommendations using correlations between aggregate wellness measures and aggregate productivity measures, according to some embodiments.

FIG. 2 is a sample user interface for setting up wellness goals as used in systems for forming recommendations using correlations between wellness and productivity, according to some embodiments.

FIG. 3 is a sample data plot showing individual productivity as a function of a selected wellness factor as used in systems for forming recommendations using correlations between wellness and productivity, according to some embodiments.

FIG. 4 is a sample data plot showing aggregate productivity as a function of aggregate employee wellness as used in systems for forming recommendations using correlations between wellness and productivity, according to some embodiments.

FIG. 5A is a correlation chart showing a positive correlation between a productivity measure and a wellness measure as used in systems for forming recommendations using correlations between wellness and productivity, according to an embodiment.

FIG. 5B is a correlation chart showing a negative correlation between a productivity measure and a wellness measure as used in systems for forming recommendations using correlations between wellness and productivity, according to an embodiment.

FIG. 6 depicts a user interface for a wellness application as used in systems for forming recommendations using correlations between wellness and productivity, according to an embodiment.

FIG. 7 is a block diagram of a system for forming recommendations using correlations between wellness and productivity, according to some embodiments.

FIG. 8 depicts a block diagram of an instance of a computer system suitable for implementing embodiments of the present disclosure.

### DETAILED DESCRIPTION

Some embodiments of the present disclosure address the problem of finding correlations between wellness and productivity. More particularly, disclosed herein and in the accompanying figures are exemplary environments, methods, and systems for forming recommendations using correlations between wellness and productivity.

### Overview

The herein disclosed wellness applications allow an employee to declare his or her personal wellness goals and to track activities and/or progress of the employee's pursuit of his or her self-declared goals. In some cases a corporate-sponsored wellness program facilitates benefit sharing. For example, an individual receives wellness compensation and/or otherwise shares in the financial benefit of taking responsibility for wellness.

In some embodiments, a wellness program allows for certain specific measures to be declared as wellness measures (e.g., hours of exercise per day) and other specific measures to be declared as productivity measures.

Examples of individual wellness measures include:
Hours of exercise or number of steps taken in a particular time period (e.g., a day),
An accounting and assessment of nutrition,
A count of the number of cups of coffee consumed in a time period,
A quantity of sports drinks or caffeine-fortified beverages consumed per time period, etc.

Examples of individual productivity measures include:
Frequency and duration of absences tallied by the individual,
Reduced healthcare premiums by individual,
Self-declared productivity (e.g., self-declared through use surveys), etc.

Examples of enterprise-wide productivity measures include:
Frequency and duration of absences in aggregate,
Reduced healthcare costs in aggregate,
Enterprise-wide financial productivity (e.g., total revenues, net income, revenue per workforce hour, etc.).

Modules within or under direction of the aforementioned wellness application are able to correlate wellness measures and work measures. For example, an employee might drink a moderate amount of coffee on a particular day at work, and that employee may report feeling very active and productive throughout the day (e.g., from the caffeine). However, the same employee might report low productivity on days when more (or less) than a moderate amount of caffeine was consumed.

The systems described herein provide mechanisms to capture wellness measures (e.g., hours of exercise, duration of workout, number of steps taken, etc.) and correlate such wellness measures with various productivity measures. Productivity measures are often direct and objective work-related measures (e.g., number of hours worked, number of units produced, sick time taken, etc.) and/or productivity measures can be self-reported aspects of productivity. Correlation between wellness measures and productivity measures can then be calculated.

In some cases, such correlations provide evidence for corporate management to make further investments in wellness programs. In some cases, such correlations provide evidence for corporate management to make changes in the administration of its wellness programs.

In exemplary embodiments a wellness program is computer-aided. Some wellness programs include data warehouses that collect data from many tracking sources, and some wellness programs' database engines that can retrieve data (e.g., from a data warehouse) and/or can process the retrieved data into formats that are used by various modules of a wellness system.

In exemplary cases, a wellness program is able to produce recommendations to an individual and/or to wellness program administrators, which in turn may encourage actions to be taken by an individual (e.g., to take a brisk 20 minute walk) and/or actions to be taken by an enterprise (e.g., establish a paid time off policy to encourage individual exercise and/or team-oriented wellness activities).

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

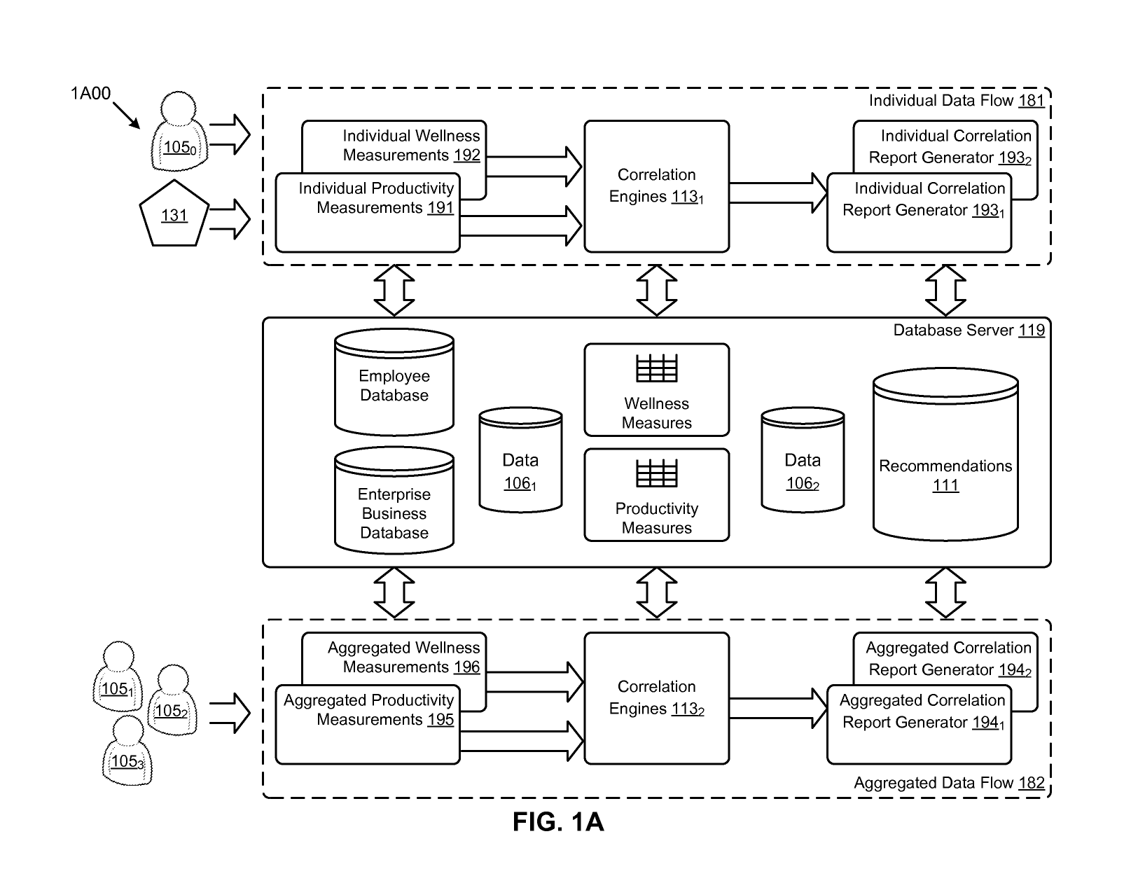

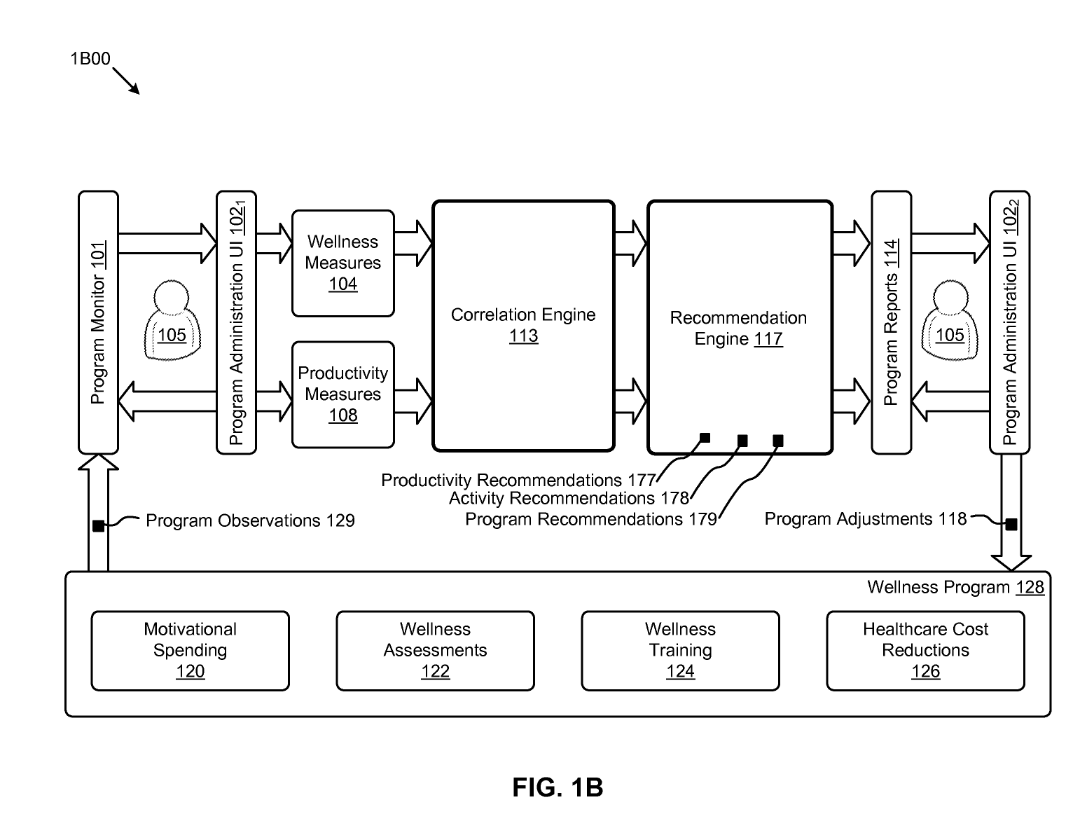

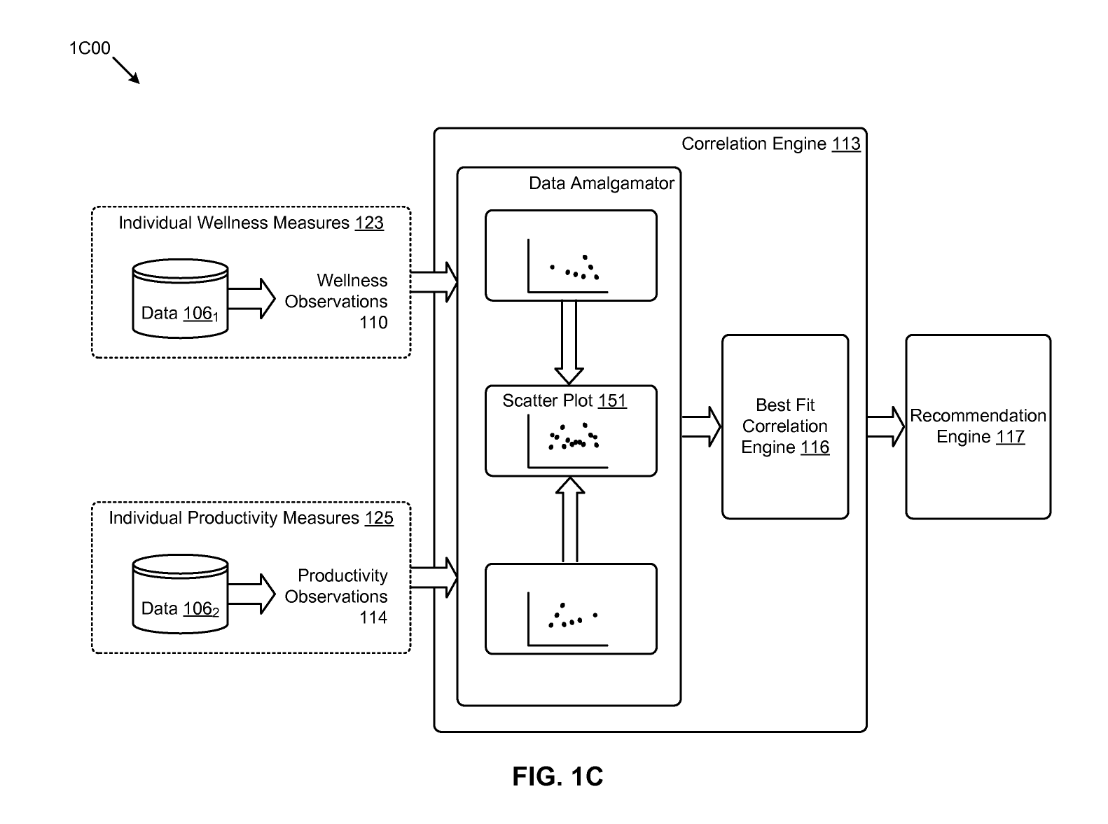

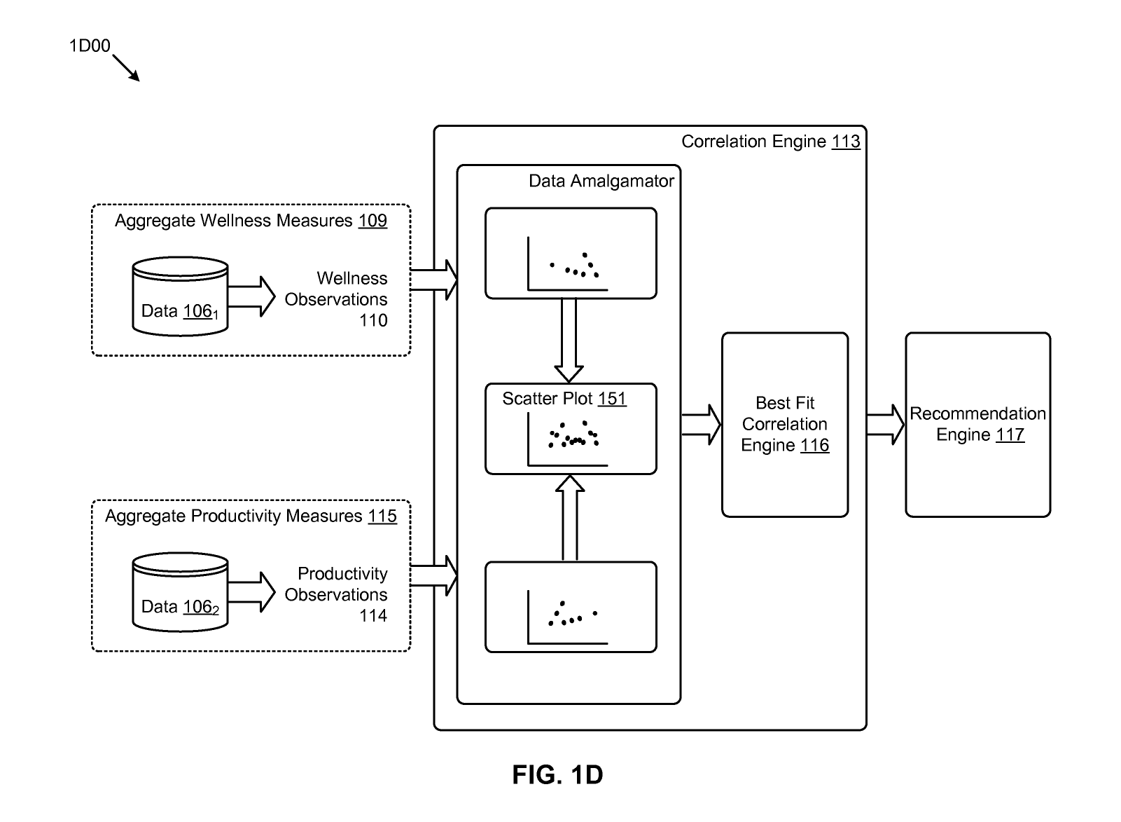

FIG. 1A exemplifies a use model and data flow 1A00 as used in systems for forming recommendations using correlations between wellness and productivity. As an option, one or more instances of data flow 1A00 or any aspect thereof may be implemented in the context of the architecture and functionality of the embodiments described herein. Also, the data flow 1A00 or any aspect thereof may be implemented in any desired environment.

As shown in FIG. 1A, data flows from a user (e.g., user 105₀, user 105₁, user 105₂, etc.) and/or from a device (e.g., pedometer 131) by way of a user interface so as to capture individual productivity measurements 191 and individual wellness measurements 192. Once captured, such measurements are stored in various area within a database and/or in storage areas accessible by a database server 119. A database server can comprise data storage devices (e.g., data 106₁, data 106₂, etc.), and can process and/or present data in tables or views. The individual productivity measurements 191 and individual wellness measurements 192 are received by a processing unit within correlation engines 113 and one or more correlation report generators (e.g., individual correlation report generator 193₁, individual correlation report generator 193₂, etc.) can produce any forms of improvement recommendations 111, which are stored in manner accessible to the database server.

The foregoing flow as pertaining to an individual (see individual data flow 181) can be followed as pertaining to an aggregation of many individuals into a group (see aggregated data flow 182). As shown in the aggregated data flow 182, data flows from a group (e.g., user 105₁, user 105₂, etc.) by way of a user interface so as to capture aggregated productivity measurements 195 and aggregated wellness measurements 196. Once captured, such measurements are stored within or accessible by a database server 119. The aggregated productivity measurements 195 and aggregated wellness measurements 196 are received by correlation engines 113₂ and one or more correlation report generators (e.g., aggregated correlation report generator 194₁, aggregated correlation report generator 194₂, etc.) produce forms of improvement recommendations 111.

The improvement recommendations 111 can be presented to an individual so as to instruct and/or motivate the individual (e.g., an employee) to take some action or actions so as to improve productivity and/or improve wellness. In other situations, the improvement recommendations 111 can be presented to a user (e.g., a wellness program administrator) so as to offer suggestions to the user so as to improve aggregate productivity and/or improve aggregate wellness throughout the organization. In some cases, an organization may sponsor a wellness program and the effectiveness of the wellness program can be affected based on implementation of one or more improvement recommendations 111. One possible example of a wellness program system, including interface to a recommendation system, is shown and discussed as pertains to the following FIG. 1B.

FIG. 1B exemplifies an interface between a wellness program system 1B00 and a system for forming recommendations using correlations between wellness and productivity. As an option, one or more instances of wellness program system 1B00 or any aspect thereof may be implemented in the context of the architecture and functionality of the embodiments described herein. Also, the wellness program 1B00 or any aspect thereof may be implemented in any desired environment.

As shown in FIG. 1B, a wellness program 128 is administered by a user (e.g., a benefits program administrator). The user can specify and/or control and/or negotiate the spending and/or performance of various functions within the wellness program. For example, and as shown, a wellness program might include functions such as incentives (e.g., motivational spending 120), employee measurements (e.g., wellness assessments 122), instruction (e.g., wellness training 124) and cost control (e.g., healthcare cost reductions 126). During the course of prosecuting the wellness program, the user 105 interfaces with a user interface (UI) such as the shown program administration UI 102₁. The user interface can specify and/or control collection of and/or usage of various wellness program-related data. In this embodiment, a recommendation engine 117 receives inputs in the form of wellness measures 104 and productivity measures 108. The recommendation engine can process received data using any forms of correlation engines 113 and produce recommendations based at least in part on the correlations.

The aforementioned wellness measures can include but are not limited to:
Exercise hours,
Steps taken,
Weight loss/gain,
Sleep hours,
Non-work/social hours.

From observed data points pertaining to such measures (e.g., program observations 129), it is also possible to capture or derive other wellness measures such as “stress” that can be calculated from the observed wellness measures. In some cases observed wellness measures can be monitored (e.g., using program monitor 101) and/or uploaded from tracking sources on wearable devices such as a “Fitbit”.

Systems according to this disclosure also serve to collect work measures that are believed to be related to wellness. Work measures can include, but are not limited to measures that include direct or indirect productivity measurements based on:
Absences,
Self-declared productivity,
Revenue per hour.

In some cases, the system integrates with an absence management application to gather absences. In such embodiments, the system sends surveys to phones and tablets to gather self-declared productivity. Productivity is declared in a 7-point Lickert scale.

In addition to the wellness measures taken in by the recommendation engine, various measures of productivity (e.g., productivity measures 108) can be processed by the recommendation engine. Such measures of productivity might be captured by any known means, including enterprise resource planning systems and/or a human resources system and/or other business applications as might be used in an enterprise.

The recommendation engine can output various forms of recommendations (e.g., productivity recommendations 177, activity recommendations 178, program recommendations 179, etc.) and/or reports, which can be read by a user 105, who can in turn take the recommendations and make changes (e.g., program adjustments 118) using the program administration UI 102₂ to effect changes to the makeup and prosecution of the wellness program 128.

The aforementioned motivational spending can include various forms of spending. For example, motivational spending might include:
Incentives paid to employees for participation in wellness programs.
Paid time off for wellness activities.
Fully-paid or partially paid time for wellness training, wellness-related games, and/or workout time.
On-the-clock pay for motivational moments such as management motivational speaking and/or management feedback sessions.
Subsidization of high nutrition meals in the cafeteria, etc.

The aforementioned productivity measures can include direct or indirect productivity measurements based on:
Absences.
Employee productivity measurements based on one or more ratios including but not limited to revenue per employee, profit per employee, revenue per work hour, profit per work hour, and/or ratios between headcount and revenue, etc.
Reduced healthcare premium costs (e.g., resulting from insurance carrier recognition of the fiscal impact of a worker's healthy years of service versus impaired years of service).

Using a system such as is depicted in environment of FIG. 1B, a benefits manager can create a mix of incentives designed to engage employees to the point of participation in a wellness program and, as indicated above, the effect of participation can be measured in terms of real and/or perceived improvements or increased wellness or well-being, which in turn results in increased individual performance (e.g., greater productivity, fewer absences, lower stress, etc.).

Some embodiments include modules beyond those shown in FIG. 1B. For example, some environments include multi-dimensional models such as (for example) relationships between incentives and participation, relationships between participation and well-being, relationships between well-being and productivity, relationships between productivity and spending, and other relationships (direct and indirect) between program spending and program benefits. Such relationships can derive, at least in part, from empirical observations (e.g., from data stored in an enterprise resource planning application).

A wellness program 128 might include any of the programs and attributes listed in Table 1:

TABLE 1
Possible Wellness Programs and Attributes

| | |
|---|---|
| Wellness Program Goals | Personal Wellness Profile |
| | and Health Goals |
| Wellness Personal Security | Wellness Teams |
| Wellness Aggregate Security | Personal Activity Tracking |
| Lifestyle Leaders Scoreboard | Personal Sleep Tracking |
| Wellness and Lifestyle Contests | Personal Stress Tracking |
| Participation Incentive Payments | Personal Lifestyle Tracking |
| Wellness and Lifestyle Education Program | Personal Nutrition Tracking |
| Wellness Survey and Assessments | Personal Brain Trainer |
| Tracking Services Interfaces | Wellness Prompts and |
| | Notifications |
| Wellness Intelligence Subject Area | Wellness Mentor Matching |
| Volunteer Opportunity Registry | Wellness Prescriptions |

Further, in addition to individual-centric program components heretofore listed, a wellness program might include enterprise-wide, aggregated wellness tracking and correlations, which in turn might include direct or indirect employee wellness measurements and/or wellness correlations such as;
Aggregated wellness and productivity measures,
Aggregated healthcare costs and wellness correlation,
Incentive and participation correlation modeling,
Participation and healthcare cost correlation modeling,
Self-assessed wellness measurements and/or predicted and surveyed wellness correlations,
Aggregate wellness and absence correlations, etc.

FIG. 1C is a block diagram of a scatter plot correlation system 1C00 for forming recommendations using correlations between individual wellness measures and individual productivity measures. As an option, one or more instances of scatter plot correlation system 1C00 or any aspect thereof may be implemented in the context of the architecture and functionality of the embodiments described herein. Also, the scatter plot correlation system 1C00 or any aspect thereof may be implemented in any desired environment.

As shown in FIG. 1C, one or more correlation engines (e.g., correlation engine 113) can amalgamate data, possibly using a data amalgamator as shown, and organize the data into a scatter plot 151. The scatter plot is in turn used by a best fit correlation engine 116 to determine and quantify a correlation. As shown, one or more wellness measures 104 (e.g., individual wellness measures 123) comprising wellness observations 110, and one or more productivity measures 108 (e.g., individual productivity measures 125) comprising productivity observations 114, can be superimposed into such a scatter plot 151. Strictly as one example, a series of observations of a particular employee's physical fitness level can be plotted, and a series of corresponding observations of a particular employee's productivity level can be superimposed to form a scatter plot 151.

The points in the scatter plot can be processed so as to formulate a line of best fit. Such a best fit curve can be formed using any known technique. The best fit curve in turn is used by a recommendation engine 117 to emit a recommendation such as, “Your more frequent workouts are tracking to higher work product output.” A recommendation engine can also emit exhortations, such as, “Keep up your daily routine—it is working well.” In some situations, causality between individual wellness measures 123 and individual productivity measures 125 can be derived and/or posited, and/or a degree of certainty of causality can be constructed mathematically (e.g., using an exponentially-weighted moving averages and/or Bayesian probabilities or other known techniques).

FIG. 1D is a block diagram of a scatter plot correlation system 1D00 for forming recommendations using correlations between aggregate wellness measures and aggregate productivity measures. As an option, one or more instances of scatter plot correlation system 1D00 or any aspect thereof may be implemented in the context of the architecture and functionality of the embodiments described herein. Also, the scatter plot correlation system 1D00 or any aspect thereof may be implemented in any desired environment.

As shown in FIG. 1D, one or more correlation engines (e.g., correlation engine 113) can amalgamate data, possibly using a data amalgamator as shown, and organize the data into a scatter plot 151. The scatter plot is in turn used by a best fit correlation engine 116 to determine and quantify a correlation. As shown, one or more aggregate wellness measures 109 comprising wellness observations 110, and one or more aggregate productivity measures 115 comprising productivity observations 114, can be superimposed into such a scatter plot 151. Strictly as one example, a series of observations of aggregated fitness levels can be plotted, and a series of corresponding observations of aggregated employee productivity can be superimposed to form a scatter plot 151.

The points in the scatter plot can be processed so as to formulate a line of best fit. Such a best fit line or curve can be formed using any known technique. The best fit line or curve in turn is used by a recommendation engine 117 to emit a recommendation (e.g., to a benefits manager). Such a recommendation might be formed as, “Target your wellness program participation rate of at least 50%”. In some situations, causality between aggregate wellness measures and aggregate productivity measures can be derived and/or posited, and/or a degree of certainty of causality can be constructed mathematically (e.g., using an exponentially-weighted moving averages and/or Bayesian probabilities or other known techniques).

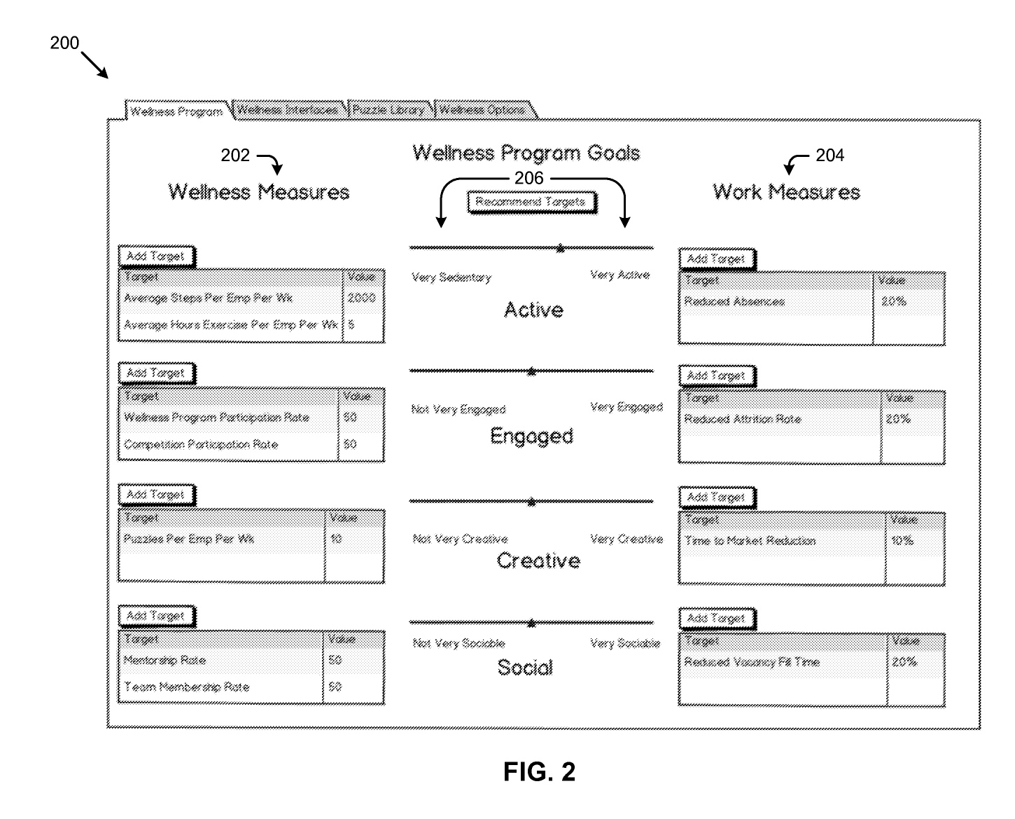

FIG. 2 is a sample user interface 200 for setting up wellness goals as used in systems for forming recommendations using correlations between wellness and productivity. As an option, one or more instances of user interface 200 or any aspect thereof may be implemented in the context of the architecture and functionality of the embodiments described herein. Also, the user interface 200 or any aspect thereof may be implemented in any desired environment.

As shown in FIG. 2, a user interface can include screen devices (e.g., for display on a computer terminal or a smartphone or a mobile device screen), and such user interfaces can include a series of wellness data (e.g., target-oriented wellness measures 202) and productivity (e.g., target-oriented work measures 204). Further, screen devices might be presented to allow a user (e.g., a benefits program administrator) to view and set wellness program goals 206 (e.g., using sliders, as shown). The example wellness measures given (“average steps per employee per week”, “wellness program participation rate”, etc.) are strictly examples, and other wellness measures and wellness measure goals are possible. Similarly, the example work measure given (“reduced absences”, “reduced attrition rate”, etc.) are strictly examples, and other work measures and work measure goals are possible.

Using such a user interface, a benefits manager can choose values corresponding to one or more employee characteristics and/or measures (e.g., social strengths, creative strengths, degree of being active, etc.). Recommendation can be biased or otherwise formulated based on a benefit's manager indication of a desire to foster one or another or a set of characteristics and/or a desire to drive wellness-related characteristics. Strictly as one scenario, a benefits manager may want to create an environment catering to “very social employees”, and a recommendation might take social interactions into account. For example, in one environment populated with employees having a particular social interaction score, a recommendation might come in the form of “Target a wellness program participation rate of at least 50%”. Such a participation rate can be related to other wellness-related characteristics or metrics. For example, a high participation rate can influence employee retention (e.g., reduce worker/position vacancies), and a team membership rate of 50% might be correlated to a lower vacancy fill time (e.g., since employees who are socially well-connected would tend to inform others of the vacancy). The relationship might be linear or might be non-linear.

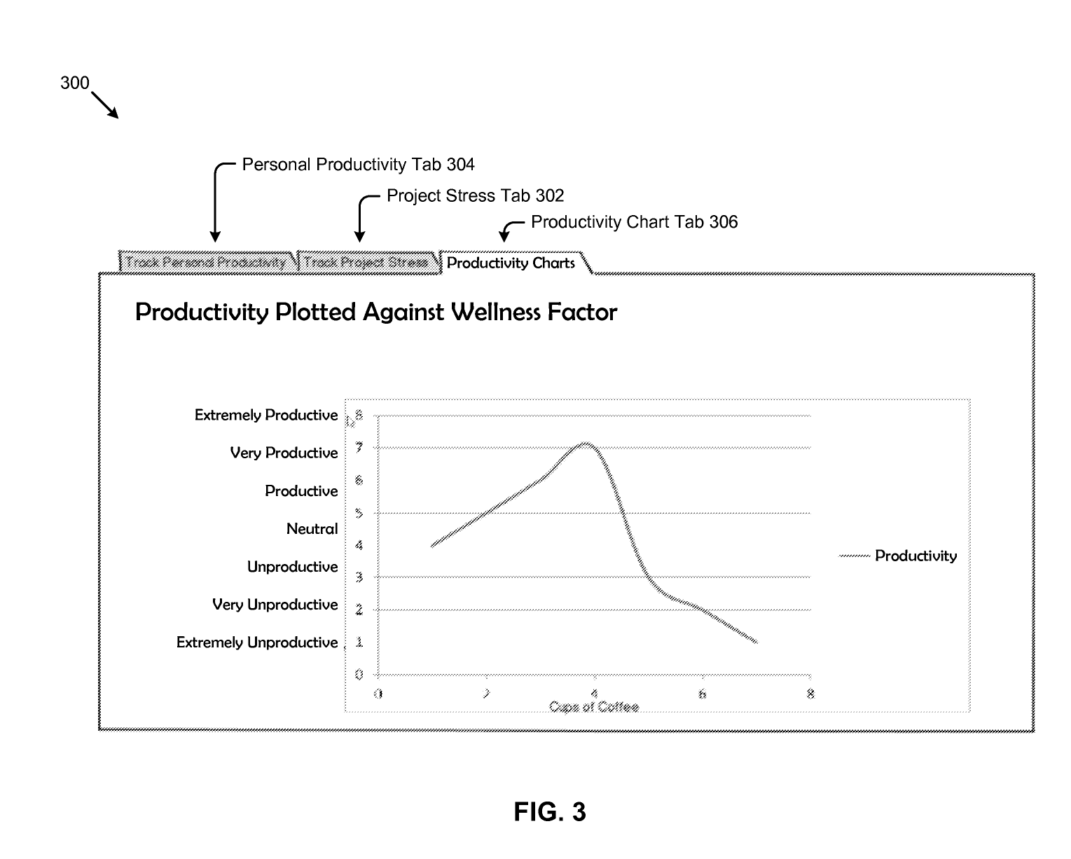

FIG. 3 is a sample data plot 300 showing individual productivity as a function of a selected wellness factor as used in systems for forming recommendations using correlations between wellness and productivity. As an option, one or more instances of data plot 300 or any aspect thereof may be implemented in the context of the architecture and functionality of the embodiments described herein. Also, the data plot 300 or any aspect thereof may be implemented in any desired environment.

As shown in FIG. 3, a productivity measure is plotted on an XY chart where the productivity measure is plotted as a function of a particular wellness factor. In this example, the productivity measure is a gradient scale from 0 to 8, characterizing a self-reported level of productivity and, in this example, the particular wellness factor is a self-reported level of consumption of coffee in units of “cups of coffee”. The foregoing is merely one example pertaining to one wellness factor, but other wellness factors are possible. Such wellness factors can be selected using screen devices found under the productivity chart tab 306.

Further, other data plots can be constructed showing individual productivity as a function of a particular wellness factor. As shown, the project stress tab 302 allows a user to track and report stress, and the personal productivity tab 304 allows a user to track and report personal productivity. In some cases wellness measures are automatically uploaded. For example, a pedometer 131 can upload “steps taken”, or “miles of walking” at any moment in time.

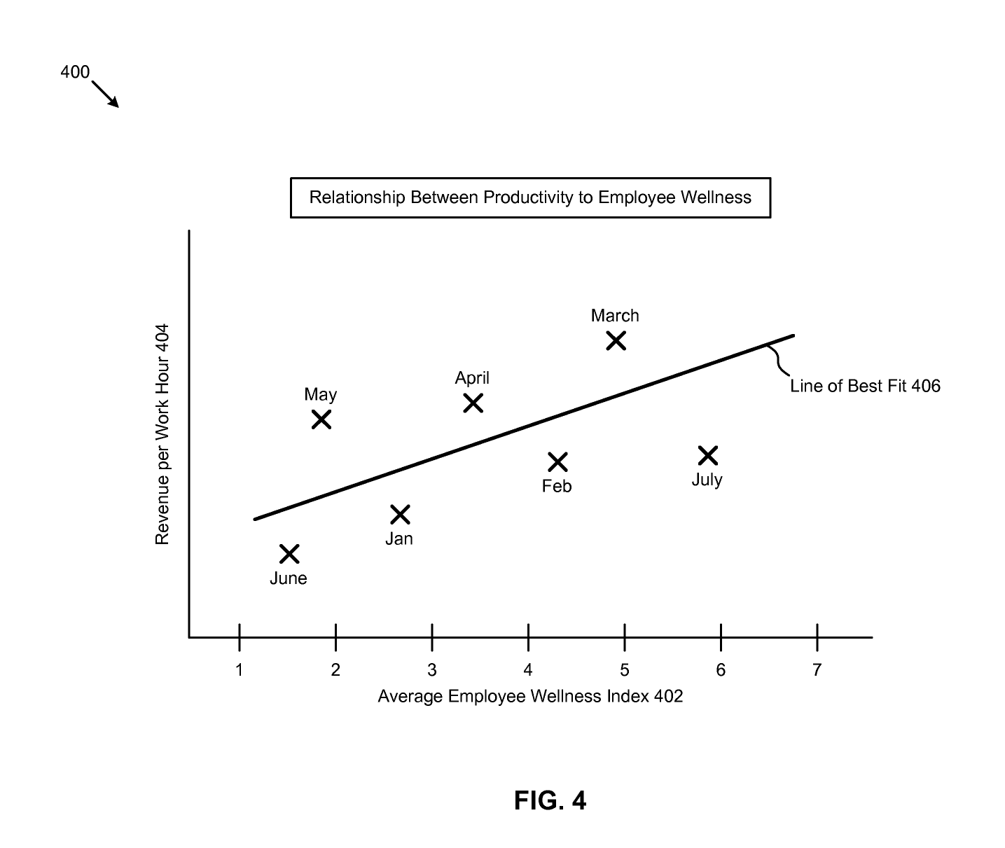

FIG. 4 is a sample data plot 400 showing aggregate productivity as a function of aggregate employee wellness as used in systems for forming recommendations using correlations between wellness and productivity. As an option, one or more instances of data plot 400 or any aspect thereof may be implemented in the context of the architecture and functionality of the embodiments described herein. Also, the data plot 400 or any aspect thereof may be implemented in any desired environment.

FIG. 4 shows aggregated data in the form of a scatter plot depicting an aggregated wellness measure (e.g., average employee wellness index 402) with respect to an aggregated productivity measure (e.g., revenue per work hour 404). In addition to the instances of points labeled in the plot, the sample data plot 400 shows a line of best fit 406, as determined by one or more correlation engines.

The sample data plot 400 substantiates the position that the organization's wellness program is working—at least inasmuch as the measured results show a positive correlation between an increase in the wellness index and an increase in revenue per work hour. Other plots are reasonable, and any number of plots that depict a wellness measure and a productivity measure can be subjected to a correlation so as to calculate and show a correlation between the selected wellness measure and the selected a productivity measure.

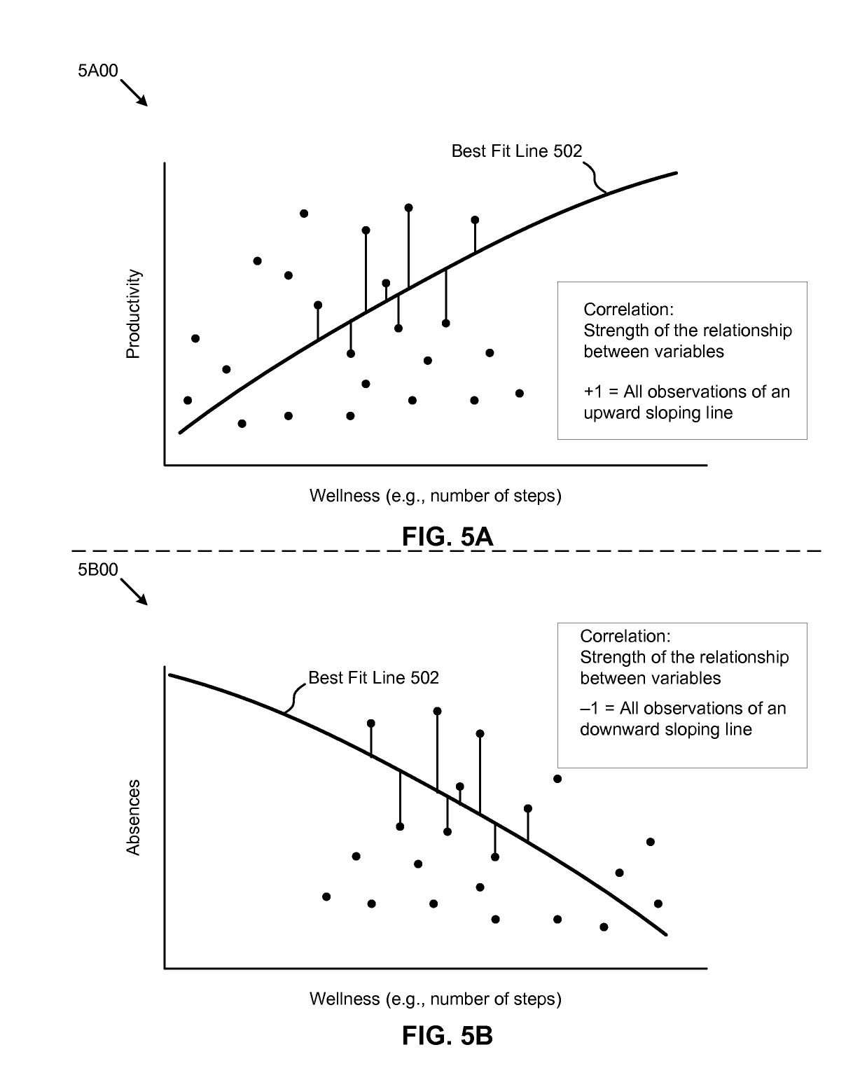

FIG. 5A is a correlation chart 5A00 showing a positive correlation between a productivity measure and a wellness measure as used in systems for forming recommendations using correlations between wellness and productivity. As an option, one or more instances of correlation chart 5A00 or any aspect thereof may be implemented in the context of the architecture and functionality of the embodiments described herein. Also, the correlation chart 5A00 or any aspect thereof may be implemented in any desired environment.

As shown in FIG. 5A, a best fit line (see best fit line 502) is drawn through a group of points on a scatter plot. Calculation of such a best fit line can proceed using any known technique. As shown, the best fit line is calculated using a linear regression technique. The example of FIG. 5A gives a series of points that yield a best fit line with a positive slope. Other situations involving wellness measures and work measures yield a series of points that yield a best fit line with a negative slope. Such an example is given in FIG. 5B.

FIG. 5B is a correlation chart 5B00 showing a negative correlation between a productivity measure and a wellness measure as used in systems for forming recommendations using correlations between wellness and productivity. As an option, one or more instances of correlation chart 5B00 or any aspect thereof may be implemented in the context of the architecture and functionality of the embodiments described herein. Also, the correlation chart 5B00 or any aspect thereof may be implemented in any desired environment.

In some cases a negative correlation corresponds to the desired set of observations. Strictly as one example, and as shown in FIG. 5B, as the aggregate wellness index increases, absences decrease. Accordingly, a system for forming recommendations using correlations between wellness and productivity might tag the sense (e.g., positive correlation or negative correlation) of a particular selected pair of wellness measures and productivity measures, and might rank a series of correlations using the correct sense of the pairing so as to model desired behavior.

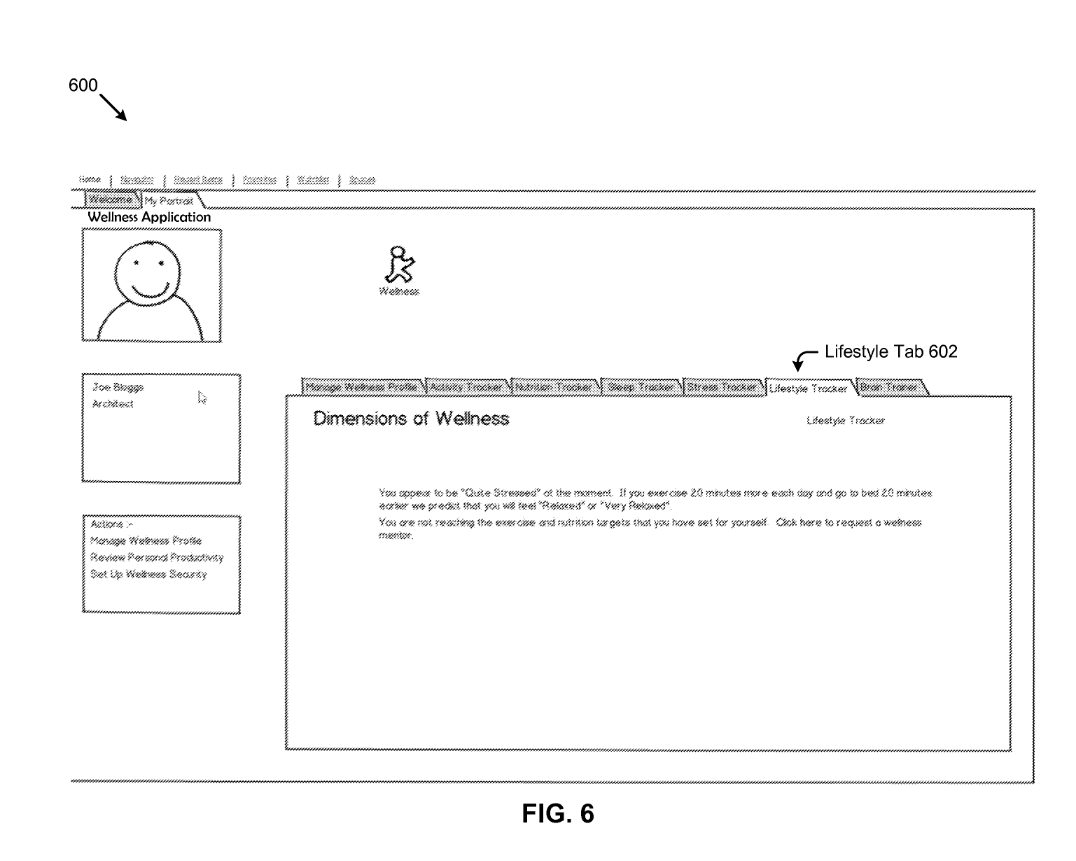

FIG. 6 depicts a user interface 600 for a wellness application as used in systems for forming recommendations using correlations between wellness and productivity, according to an embodiment. As an option, one or more instances of user interface 600 or any aspect thereof may be implemented in the context of the architecture and functionality of the embodiments described herein. Also, the user interface 600 or any aspect thereof may be implemented in any desired environment.

As shown, a user interface screen can comprise a component of a wellness application. Such a user interface can be customized to fit the branding and/or culture of the sponsoring organization. In some cases the interface screen can include many dimensions of wellness, and any one or more dimensions can be displayed using any known technique. The lifestyle tab 602 presents a recommendation to the user. Such a recommendation is based at least in part on the aforementioned wellness measures and productivity measures. The recommendation engine can be configured to present recommendations in prose (e.g., as shown) or can be configured to present recommendation in the form of rankings (e.g., a chart showing rankings among peers). A recommendation can be a recommendation to a benefits program manager, or to an individual. One example of a recommendation to an individual employee might be, “You reported yourself as not very productive yesterday. However, on days when you walk 1000 steps or more, you report yourself as productive. Try going for a brisk walk each day after lunch”.

In addition to recommendations made to an employee, the recommendation engine can be configured to present recommendations to a benefits manager. One example of a recommendation to a benefits manager might be, “In order to achieve a 5% reduction in absences, your workforce needs to take an average of 1000 steps per day”.

### ADDITIONAL EMBODIMENTS OF THE DISCLOSURE

### Additional Practical Application Examples

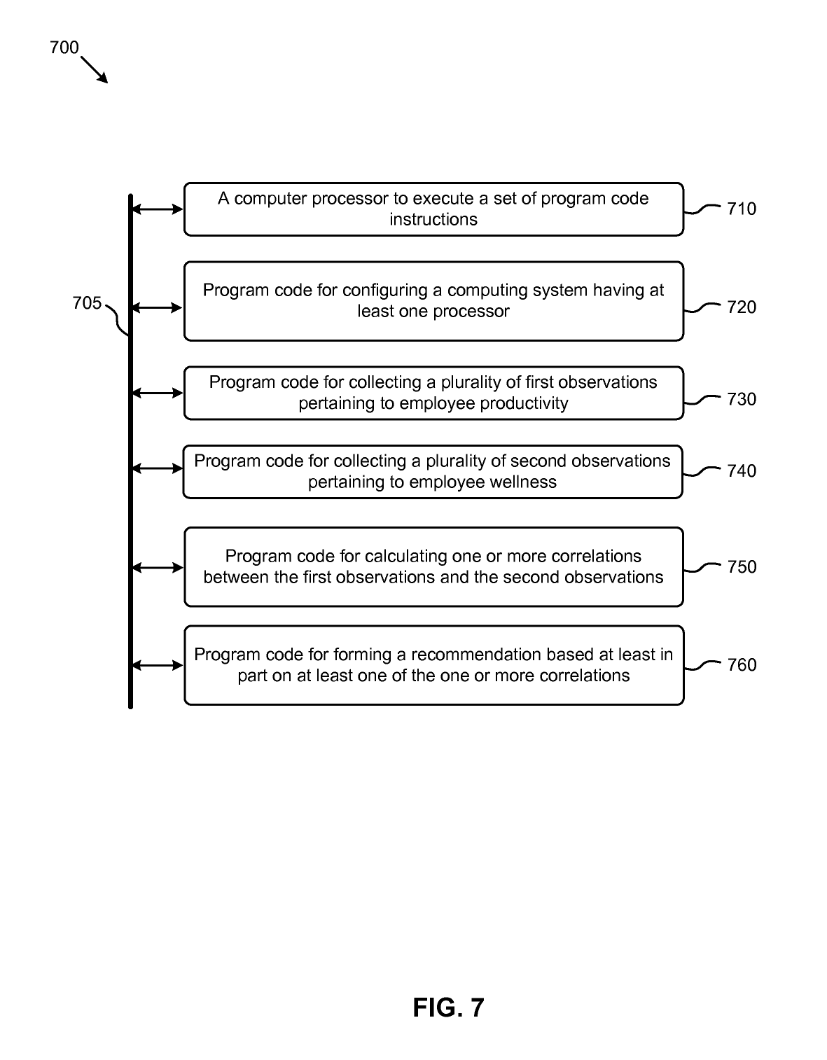

FIG. 7 is a block diagram of a system for forming recommendations using correlations between wellness and productivity. As an option, the present system 700 may be implemented in the context of the architecture and functionality of the embodiments described herein. Of course, however, the system 700 or any operation therein may be carried out in any desired environment. As shown, system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims. The embodiment of FIG. 7 implements a portion of a computer system, shown as system 700, comprising a computer processor to execute a set of program code instructions (see module 710) and modules for accessing memory to hold program code instructions to perform: configuring a computing system having at least one processor to perform at least some steps of a process (see module 720); collecting a plurality of first observations pertaining to employee productivity (see module 730); collecting a plurality of second observations pertaining to employee wellness (see module 740); calculating one or more correlations between the first observations and the second observations (see module 750); and forming a recommendation based at least in part on at least one of the one or more correlations (see module 760).

### System Architecture Overview

### Additional System Architecture Examples

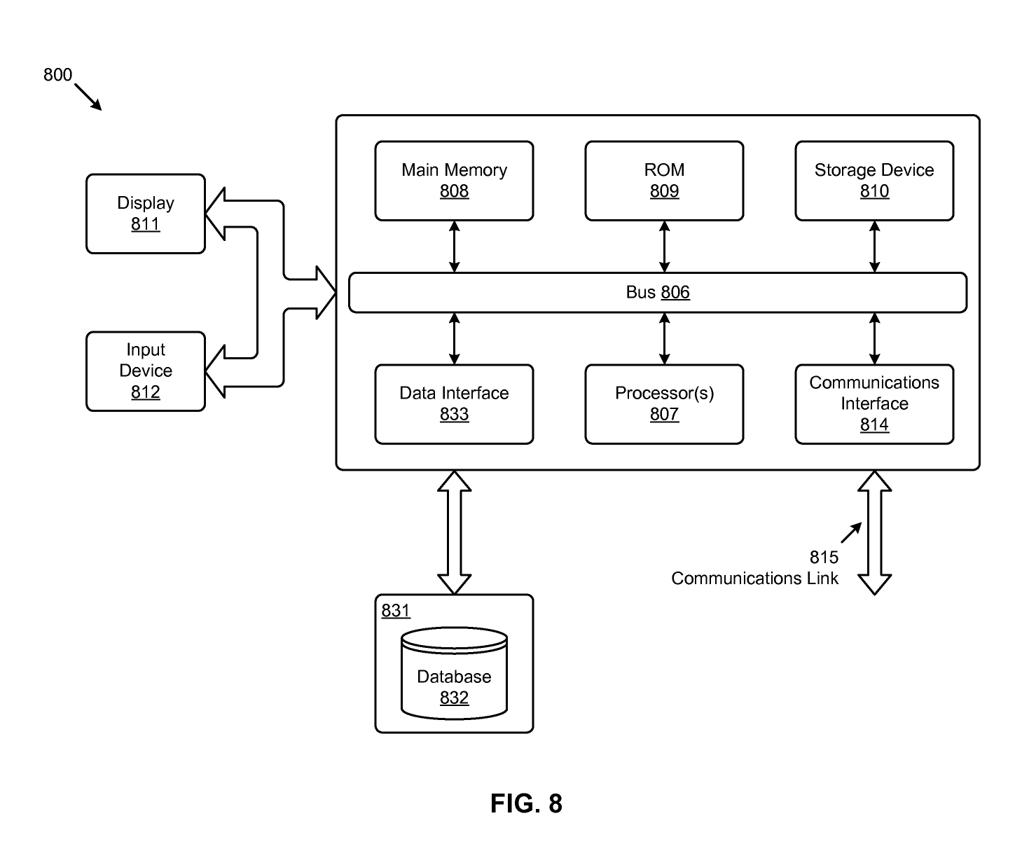

FIG. 8 depicts a block diagram of an instance of a computer system 800 suitable for implementing an embodiment of the present disclosure. Computer system 800 includes a bus 806 or other communication mechanism for communicating information, which interconnects subsystems and devices, such as a processor 807, a system memory 808 (e.g., RAM), a static storage device (e.g., ROM 809), a disk drive 810 (e.g., magnetic or optical), a data interface 833, a communication interface 814 (e.g., modem or Ethernet card), a display 811 (e.g., CRT or LCD), input devices 812 (e.g., keyboard, cursor control), and an external data repository 831.

According to one embodiment of the disclosure, computer system 800 performs specific operations by processor 807 executing one or more sequences of one or more instructions contained in system memory 808. Such instructions may be read into system memory 808 from another computer readable/usable medium, such as a static storage device or a disk drive 810. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 807 for execution. Such a medium may take many forms, including but not limited to, non-volatile media and volatile media. Non-volatile media includes, for example, optical or magnetic disks, such as disk drive 810. Volatile media includes dynamic memory, such as system memory 808.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 800. According to certain embodiments of the disclosure, two or more computer systems 800 coupled by a communications link 815 (e.g., LAN, PTSN, or wireless network) may perform the sequence of instructions required to practice the disclosure in coordination with one another.

Computer system 800 may transmit and receive messages, data, and instructions, including programs (e.g., application code), through communications link 815 and communication interface 814. Received program code may be executed by processor 807 as it is received and/or stored in disk drive 810 or other non-volatile storage for later execution. Computer system 800 may communicate through a data interface 833 to a database 832 on an external data repository 831. Data items in database 832 can be accessed using a primary key (e.g., a relational database primary key). A module as used herein can be implemented using any mix of any portions of the system memory 808, and any extent of hard-wired circuitry including hard-wired circuitry embodied as a processor 807.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A method comprising:
identifying a computing system having a storage subsystem, wherein the storage subsystem comprises at least a database area having a series of records stored on a computer-readable medium, where individual records are accessed using at least a primary key;
collecting, from a first database area, a plurality of first observations pertaining to employee productivity, the first observations comprising direct or indirect productivity measurements;
collecting, from a second database area, a plurality of second observations pertaining to employee wellness, the second observations comprising direct or indirect employee wellness measurements;
calculating, using the processor, one or more correlations between the first observations and the second observations; and
forming a recommendation based at least in part on at least one of the one or more correlations.

2. The method of claim 1, wherein first observations pertaining to employee productivity comprise at least one of, working hours per time period, absentee hours per time period, units produced over a time period, revenue per employee, profit per employee, revenue per work hour, and profit per work hour.

3. The method of claim 2, wherein first observations pertaining to employee productivity further comprise measures of corporate financial performance.

4. The method of claim 1, wherein second observations pertaining to employee wellness comprise an assessment of at least one of, a number of hours of exercise per time period, a number of steps taken per time period, a nutrition intake per time period, a body characteristic, and a quantity of caffeine-fortified beverages consumed per time period.

5. The method of claim 1, wherein the correlations comprise correlation of individual employee participation to individual employee productivity.

6. The method of claim 1, wherein the correlations comprise correlation between aggregate employee participation to aggregate employee productivity.

7. The method of claim 1, wherein the correlations comprise correlation between aggregate employee participation in a wellness program and corporate financial performance.

8. The method of claim 1, wherein the recommendation comprises one or more activity recommendations.

9. The method of claim 1, wherein the recommendation comprises one or more wellness program recommendations.

10. The method of claim 1, wherein the recommendation comprises a productivity recommendation.

11. A computer program product embodied in a non-transitory computer readable medium, the computer readable medium having stored thereon a sequence of instructions which, when executed by a processor causes the processor to execute a process, the process comprising:
collecting a plurality of first observations pertaining to employee productivity, the first observations comprising direct or indirect productivity measurements;
collecting a plurality of second observations pertaining to employee wellness, the second observations comprising direct or indirect employee wellness measurements;
calculating one or more correlations between the first observations and the second observations; and
forming a recommendation based at least in part on at least one of the one or more correlations.

12. The computer program product of claim 11, wherein first observations pertaining to employee productivity comprise at least one of, working hours per time period, absentee hours per time period, units produced over a time period, revenue per employee, profit per employee, revenue per work hour, and profit per work hour.

13. The computer program product of claim 12, wherein first observations pertaining to employee productivity further comprise measures of corporate financial performance.

14. The computer program product of claim 11, wherein second observations pertaining to employee wellness comprise an assessment of at least one of, a number of hours of exercise per time period, a number of steps taken per time period, a nutrition intake per time period, a body characteristic, and a quantity of caffeine-fortified beverages consumed per time period.

15. The computer program product of claim 11, wherein the correlations comprise correlation between aggregate employee participation in a wellness program and corporate financial performance.

16. The computer program product of claim 11, wherein the recommendation comprises one or more activity recommendations.

17. The computer program product of claim 11, wherein the recommendation comprises one or more wellness program recommendations.

18. The computer program product of claim 11, wherein the recommendation comprises a productivity recommendation.

19. A system comprising:
a database server to collect a plurality of first observations pertaining to employee productivity, the first observations comprising direct or indirect productivity measurements, and to collect a plurality of second observations pertaining to employee wellness, the second observations comprising direct or indirect employee wellness measurements;
a correlation engine to calculate one or more correlations between the first observations and the second observations; and
a recommendation engine to form a recommendation based at least in part on at least one of the one or more correlations.

20. The system of claim 19, wherein first observations pertaining to employee productivity comprise at least one of, working hours per time period, absentee hours per time period, units produced over a time period, revenue per employee, profit per employee, revenue per work hour, and profit per work hour.
